(19) United States
(12) Patent Application Publication
(10) Pub. No.: US 2025/0068972 A1
(43) Pub. Date: Feb. 27, 2025

(54) Method for Obfuscating Device Functionality

(71) Applicant: Google LLC, Mountain View, CA (US)

(72) Inventors: Matthew Royce Markwell, Mountain View, CA (US); Nahid Farhady Ghalaty, San Diego, CA (US)

(21) Appl. No.: 18/724,528

(22) PCT Filed: Dec. 30, 2022
(86) PCT No.: PCT/US2022/082626

§ 371 Date: Jun. 26, 2024

Related U.S. Application Data
(60) Provisional application No. 63/299,259, filed on Jan. 13, 2022.

(51) Int. Cl. G06N 20/00; G06F 21/14

(52) U.S. Cl. CPC G06N 20/00; G06F 21/14

(57) ABSTRACT

A computer-implemented method performed on a device comprises receiving input data that describes one or more machine learning (ML) model characteristics of an ML model to be scheduled for execution by the device. The method further comprises determining, based on the one or more ML model characteristics of the ML model, one or more obfuscation instructions to execute concurrently or sequentially with execution of model instructions associated with the ML model. Execution of the one or more obfuscation instructions obfuscates a profile of a measurable parameter associated with the device executing the model instructions. The method further comprises executing the one or more determined obfuscation instructions concurrently or sequentially with execution of the model instructions.

### REFERENCE TO RELATED APPLICATION

The present application claims priority to U.S. Provisional Application No. 63/299,259, filed Jan. 13, 2022, the contents of which are hereby incorporated by reference.

### BACKGROUND

### Field

This application generally relates to devices that comprise computer processors. In particular, this application describes a method for obfuscating device functionality and a device that implements the method.

### Description of Related Art

Many devices implement proprietary processes that provide manufacturers of these devices a competitive advantage over their rivals. Some of these processes also improve device security. For example, a particular device may include a face detection feature that facilitates convenient unlocking of the device by the owner of the device. Considerable research and development time may have been spent in implementing the feature.

In some instances, a rival manufacturer or an unscrupulous user may gain insight into the inner workings of the implementation of the feature by observing how the device behaves when the feature is being utilized. For example, the power consumed by inference hardware that implements a particular feature can, in some instances, provide insight into the number of layers the inference model utilizes, the weights associated with nodes of the layers, activations functions of the nodes, etc. This insight may allow a rival to rapidly develop a competing version of the feature or may allow an unscrupulous user to determine security vulnerabilities in the feature.

### SUMMARY

In a first aspect, a computer-implemented method performed on a device comprises receiving input data that describes one or more machine learning (ML) model characteristics of an ML model to be scheduled for execution by the device. The method further comprises determining, based on the one or more ML model characteristics of the ML model, one or more obfuscation instructions to execute concurrently or sequentially with the execution of model instructions associated with the ML model. Execution of the one or more obfuscation instructions obfuscates a profile of a measurable parameter associated with the execution of the model instructions by the device. The method further comprises executing the one or more determined obfuscation instructions concurrently or sequentially with the execution of the model instructions.

In a second aspect, a computing device includes a memory and a processor and the memory stores instruction code. The processor is in communication with the memory. The instruction code is executable by the processor to cause the computing system to perform operations that comprise receiving input data that describes one or more machine learning (ML) model characteristics of an ML model to be scheduled for execution by the computing device. The operations further comprise determining, based on the one or more ML model characteristics of the ML model, one or more obfuscation instructions to execute concurrently or sequentially with the execution of model instructions associated with the ML model. Execution of the one or more obfuscation instructions obfuscates a profile of a measurable parameter associated with the execution of the model instructions by the computing device. The operations further comprise executing the one or more determined obfuscation instructions concurrently or sequentially with the execution of the model instructions.

In a third aspect, a non-transitory computer-readable medium has instruction code stored thereon. When the instruction code is executed by a processor of a computing system, the computing system performs operations that comprise receiving input data that describes one or more machine learning (ML) model characteristics of an ML model to be scheduled for execution by the computing system. The operations further comprise determining, based on the one or more ML model characteristics of the ML model, one or more obfuscation instructions to execute concurrently or sequentially with the execution of model instructions associated with the ML model. Execution of the one or more obfuscation instructions obfuscates a profile of a measurable parameter associated with the execution of the model instructions by the computing system. The operations further comprise executing the one or more determined obfuscation instructions concurrently or sequentially with the execution of the model instructions.

In a fourth aspect, a device comprises means for receiving input data that describes one or more machine learning (ML) model characteristics of an ML model to be scheduled for execution by the device. The device further comprises means for determining, based on the one or more ML model characteristics of the ML model, one or more obfuscation instructions to execute concurrently or sequentially with the execution of model instructions associated with the ML model. Execution of the one or more obfuscation instructions obfuscates a profile of a measurable parameter associated with the execution of the model instructions by the device. The device further comprises means for executing the one or more determined obfuscation instructions concurrently or sequentially with the execution of the model instructions.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an environment that includes a device and a sensing system, in accordance with example embodiments.

FIG. 2 illustrates a block diagram of a device, in accordance with example embodiments.

FIG. 3 illustrates machine-learning (ML) logic, in accordance with example embodiments.

FIG. 4 illustrates operations that facilitate scheduling an obfuscated model on ML logic, in accordance with example embodiments.

FIG. 5A illustrates a measurable parameter profile associated with the execution of model instructions, in accordance with example embodiments.

FIG. 5B illustrates a measurable parameter profile associated with obfuscation instructions, in accordance with example embodiments.

FIG. 5C illustrates a measurable parameter profile of a device that is associated with concurrent execution of the model instructions of FIG. 5A and the obfuscation instructions of FIG. 5B, in accordance with example embodiments.

FIG. 6A illustrates a measurable parameter profile associated with the execution of model instructions, in accordance with example embodiments.

FIG. 6B illustrates a measurable parameter profile associated with obfuscation instructions, in accordance with example embodiments.

FIG. 6C illustrates a measurable parameter profile of a device that is associated with concurrent execution of the model instructions of FIG. 6A and the obfuscation instructions of FIG. 6A, in accordance with example embodiments.

FIG. 7A illustrates a measurable parameter profile associated with the execution of model instructions, in accordance with example embodiments.

FIG. 7B illustrates a measurable parameter profile associated with the execution of obfuscation instructions, in accordance with example embodiments.

FIG. 7C illustrates a measurable parameter profile of a device that is associated with concurrent execution of the model instructions of FIG. 7A and the obfuscation instructions of FIG. 7B, in accordance with example embodiments.

FIG. 8 illustrates operations performed by a device, in accordance with example embodiments.

FIG. 9 illustrates a computer system, in accordance with example embodiments.

### DETAILED DESCRIPTION

Various examples of systems, devices, and/or methods are described herein. Any embodiment, implementation, and/or feature described herein as being an example is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially” or “about” that may be used herein are meant that the recited characteristic, parameter, or value need not be achieved exactly, but that deviations or variations, including, for example, tolerances, measurement error, measurement accuracy limitations and other factors known to those skilled in the art, may occur in amounts that do not preclude the effect the characteristic was intended to provide.

As noted above, certain measurable parameters of a device, such as the power consumed by a device, can, in some instances, provide insight into the way a particular feature is implemented. This insight may allow others to rapidly develop a competing version of the feature or may allow an unscrupulous user to determine security vulnerabilities in the feature.

For example, a secure process or application on a device may implement a face authentication feature using machine learning (ML) inference. As used herein, ML inference corresponds to hardware configured to execute ML instructions that implement a trained ML model. The ML inference may reside on the device (e.g., an edge device) as opposed to in the cloud (e.g., operating on a server). Since the process is a security-sensitive authentication mechanism, keeping details about the ML models secret is important. In this regard, the model instructions associated with the ML model may be encrypted on the device. Further, the device may incorporate various hardware and software protective measures to prevent the models from being directly analyzed.

The model instructions may be executed on a special processing unit of the device (e.g., inference hardware), and the power dissipated by the processing unit may be measured during the execution of the model instructions. The change in power dissipation during the execution of the model instructions may provide insight into the particular processes being performed by the model. For example, with some rudimentary knowledge of the hardware architecture, one may be able to determine aspects of the ML model such as the number of layers, the number of nodes in each layer, the activation function used in each layer, and the input weights to each neuron.

Examples disclosed herein obfuscate power/leakage and EM information available to attackers by the introduction of dummy or arbitrary work in the ML inference hardware. Generally, on-device inference is scheduled to the physical hardware at compile-time. The introduction of concurrent arbitrary work during inference introduces enough noise in the physical characteristics of the inference visible through side-channel attacks (SCA) to prevent the reverse-engineering of the details of the model.

In some examples, the arbitrary work is introduced in the form of scheduled concurrent work on different processing units in the inference hardware that is compiled into the same binary. In some examples, an independent obfuscation binary is created that is scheduled concurrently with ML models that implement security-sensitive processes.

In some examples, the arbitrary work introduced is random to increase efficacy at hiding SCA information. In some examples, for ML compilation systems that do not support changes in control-flow, randomness is emulated by creating a larger set of deterministic obfuscation binaries and making the order they are scheduled onto the ML hardware random, but still concurrent with the real, secret models.

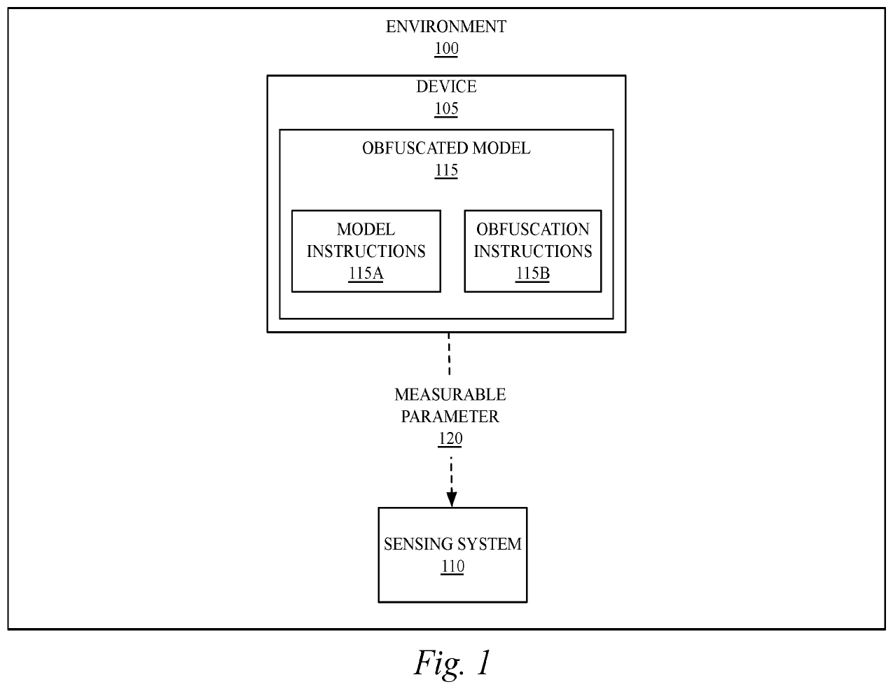

FIG. 1 illustrates an example of an environment 100 that includes a device 105 and a sensing system 110. An example of the device 105 corresponds to an edge device (e.g., a device that is in possession of an end-user). Examples of the device 105 correspond to a smartphone, tablet, wearable device, personal computer, etc.

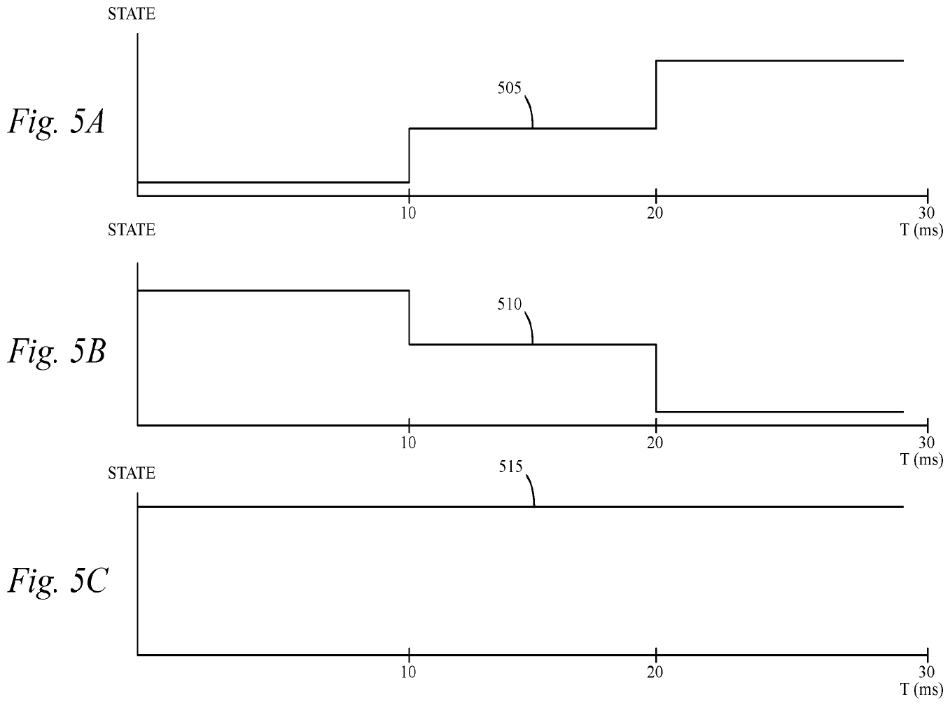

Some examples of the device 105 execute an obfuscated model 115. Some examples of the obfuscated model 115 comprise model instructions 115A and obfuscation instructions 115B. Some examples of the model instructions 115A define a ML model that facilitates the implementation of ML-based applications, such as face detection, voice recognition, fingerprint recognition, etc. In some examples, a model configured based solely according to the model instructions 115A (e.g., a non-obfuscated model) causes changes in measurable parameters 120 of the device 105. For example, execution of the non-obfuscated model causes changes in the power dissipation of the device 105 or in the amount of EM energy emitted from the device 105. In some examples, the changes in the measurable parameters 120 follow a particular profile (e.g., as shown in FIG. 5A) during the execution of the non-obfuscated model.

In this regard, some examples of the obfuscation instructions 115B define miscellaneous processes (e.g., “dummy work”) not necessarily configured to produce any meaningful output. In some examples, the one or more obfuscation instructions 115B are concurrently or sequentially executed with the model instructions 115A to obfuscate the particular profile of the measurable parameter 120 of the device 105 that is associated with the execution of the non-obfuscated model.

Some examples of the sensing system 110 correspond to test equipment configured to sense measurable parameters 120 of the device 105. For instance, an example of the sensing system 110 corresponds to an oscilloscope. The oscilloscope can be configured to measure, for example, the power dissipation of the device 105 during the execution of a non-obfuscated model and an obfuscated model 115. In some examples, the change in power dissipation during the execution of the non-obfuscated model follows a particular profile, and this profile can be used to ascertain the inner workings of the non-obfuscated model.

Another example of the sensing system 110 corresponds to a radio frequency (RF) analyzer. The RF analyzer can be configured to measure, for example, electromagnetic (EM) energy emanating from the device 105 during the execution of a non-obfuscated model and an obfuscated model 115. In some examples, the change in EM energy (e.g., changes in frequency and amplitude) during the execution of the non-obfuscated model follows a particular profile, and this profile can be used to ascertain the inner workings of the non-obfuscated model.

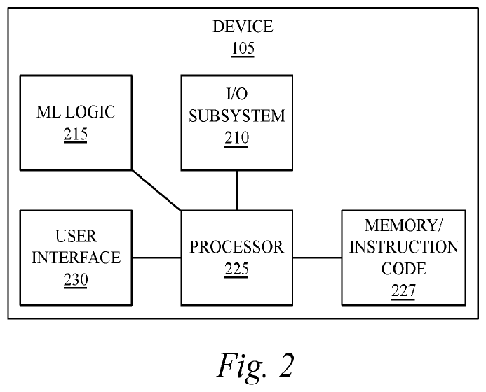

FIG. 2 illustrates a block diagram of an example of a device 105. Referring to the figure, the device 105 includes a memory 227, a processor 225, a user interface 230, an input/output (I/O) subsystem 210, and ML logic 215.

The processor 225 is in communication with the memory 227 and is configured to execute instruction code stored in the memory 227. The instruction code facilitates performing, by the device 105, various operations that are described herein. In this regard, some examples of the instruction code cause the processor 225 to control and coordinate various activities performed by the different subsystems of the device 105. Some examples of the processor 225 correspond to a stand-alone computer system such as an ARM®, Intel®, AMD®, or PowerPC® based computer system or a different computer system and can include application-specific computer systems. Some examples of the computer system include an operating system. Examples of the operating system include Android™, Windows®, Linux®, Unix®, or a different operating system.

Some examples of the user interface 230 include display circuitry. Examples of the display circuitry include a liquid crystal display (LCD), light-emitting diode display (LED) display, etc. Some examples of the display include a transparent capacitive touchpad that facilitates receiving user commands. In this regard, some examples of the display circuitry are configured to present a graphical user interface (GUI). Some examples of the user interface 230 include cameras that facilitate the performance of facial recognition. Some examples of the user interface 230 include microphones that facilitate the performance of voice recognition. Some examples of the user interface 230 include fingerprint readers that facilitate the performance of fingerprint recognition.

Some examples of the I/O subsystem 210 include one or more input/output interfaces configured to facilitate communications with entities outside of the device 105. Some examples of the I/O subsystem 210 include wireless communication circuitry configured to facilitate communicating information to and from the device 105. Examples of the wireless communication circuitry include cellular telephone communication circuitry configured to communicate information over a cellular telephone network such as a 3G, 4G, and/or 5G network. Other examples of the wireless communication circuitry facilitate the communication of information via a WiFi-based network, Bluetooth®, Zigbee®, near field communication technology or a different wireless network.

Some examples of the ML logic 215 include hardware, software, or a combination thereof that is specifically configured to implement or assist in the implementation of various supervised and unsupervised machine learning models. Within examples, these involve implementation of a Holt-Winters algorithm, exponential time smoothing (ETS) algorithm, an artificial neural network (ANN), a recurrent neural network (RNN), convolutional neural network (CNN), a seasonal autoregressive moving average (SARIMA) algorithm, a network of long short-term memories (LSTM), a gated recurrent unit (GRU) algorithm. Some examples of the ML logic 215 implement other machine learning (ML) logic and/or artificial intelligence (AI) algorithms.

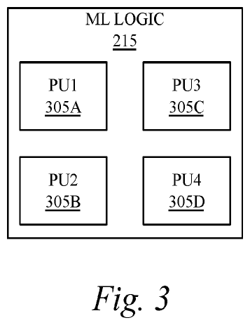

FIG. 3 illustrates an example of ML logic 215. Referring to FIG. 3, the ML logic 215 comprises a group of processing units 305A-D. An example of a processing unit 305 corresponds to a complex instruction set computer (CISC) processor. Some examples of the processing unit 305 include hardware and a corresponding instruction set that facilitates performing operations such as matrix multiplication or convolution, the application of activation functions, floating-point computations, etc.

In some examples, the number of processing units 305 used when implementing a particular obfuscated model 115 depends on the complexity of the obfuscated model 115 (e.g., the number of layers, nodes in the layers, etc., specified by the model instructions 115A of the obfuscated model 115). In this regard, in some examples, the model instructions 115A of the obfuscated model 115 are executed by a subset of the processing units 305A, 305B. In some examples, obfuscation instructions 115B of the obfuscated model 115 are executed by a different subset of processing units 305C, 305D.

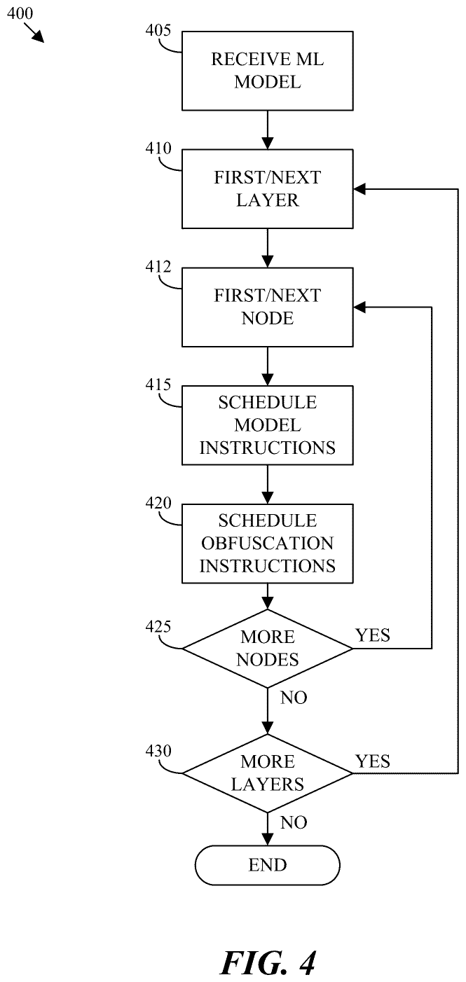

FIG. 4 illustrates examples of operations 400 that facilitate scheduling the obfuscated model 115 on the ML logic 215. At block 405, a ML model is received. At block 410, the first layer of the ML model is selected, and at block 415, the first node of that layer is selected.

At block 415, model instructions 115A associated with the selected node are scheduled. As noted above, in some examples, the model instructions 115A are scheduled for execution by a first subset of the processing units 305A, 305B.

At block 420, obfuscation instructions associated with the selected node are scheduled. As noted above, in some examples, the obfuscation instructions 115B are scheduled for execution by a second subset of the processing units 305C, 305D. Some examples ofthe obfuscation instructions 1151B are configured to implement a loop that iterates a particular number of times to obfuscate changes in the measurable parameter due to execution of the model instructions 115A by the first subset of processing units 305A, 305B at block 415. The number of times is increased to, for example, increase the power dissipation or EM energy of the device 105 associated with the execution of the obfuscation instructions 115B. The number of times is decreased to decrease the power dissipation or EM energy of the device 105 associated with the execution of the obfuscation instructions 115B.

In some examples, the obfuscation instructions 115B associated with a particular node are configured to execute concurrently with the execution of the model instructions 115A associated with the node. For example, the model instructions 115A execute on the first subset of processing units 305A, 305B, and then the obfuscation instructions 115A execute on the same processing units 305A, 305B after the execution of the model instructions 115A is complete. In some examples, the obfuscation instructions 115B associated with a particular node are configured to execute concurrently with the execution of the model instructions 115A. For example, the model instructions 115A execute on the first subset of processing units 305A, 305B, and the obfuscation instructions 115B execute concurrently on the second subset of processing units 305C, 305D.

At block 425, if there are additional nodes, the operations repeat from block 410. Otherwise, if at block 430 there are additional layers, the operations repeat from block 405.

As noted above, a model configured based solely according to the model instructions 115A (e.g., a non-obfuscated model) causes particular changes in measurable parameters 120 of the device 105 that can be utilized to determine the inner workings of the model. The obfuscation instructions 115B are concurrently or sequentially executed with the model instructions 115A to obfuscate changes in the measurable parameter 120 associated with the execution of the model instructions 115A.

FIGS. 5A and 5B illustrate examples of measurable parameter profiles 505, 510 associated with the execution of model instructions 115A and the obfuscation instructions 115B, respectively. In some examples, the respective measurable parameter profiles 505, 510 are associated with the execution of the instructions on the ML logic 215, described above.

In the figures, the measurable parameter 120 associated with the model instructions 115A and the obfuscation instructions 115B transition between first, second, and third states during first, second, and third intervals (e.g., 10 ms intervals), respectively, during execution.

For instance, when the measurable parameter 120 corresponds to the power dissipation or EM energy of the device 105, the measurable parameter profile 505 associated with the model instructions 115A indicates that the power dissipation or EM energy associated with the execution of the model instructions 115A transitions between successively higher power levels during the first, second, and third intervals. The measurable parameter profile 510 associated with the obfuscation instructions 115B indicates that the power dissipation or EM energy associated with the execution of the obfuscation instructions 115B transitions between successively lower power levels or EM energy during the first, second, and third intervals.

FIG. 5C illustrates an example of the measurable parameter profile 515 of the device 105 that is associated with the execution of the model instructions 115A and the obfuscation instructions 115B described above. As shown, the measurable parameter profile 515 associated with the combined execution of these instructions is relatively constant, thus obfuscating the measurable parameter profile 505 associated with the obfuscated model 115.

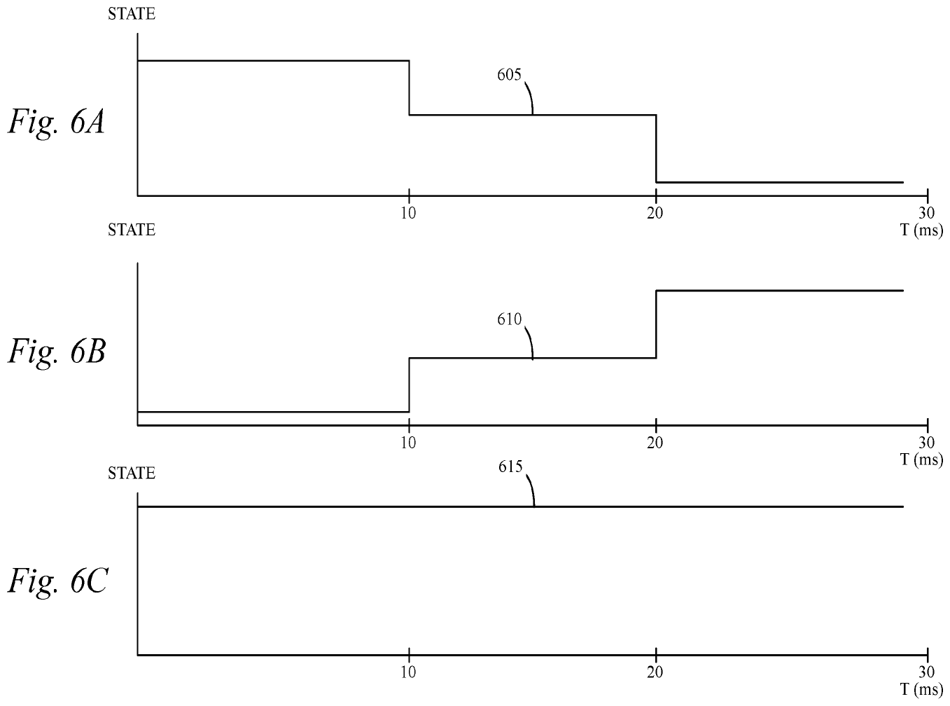

FIGS. 6A and 6B illustrate other examples of measurable parameter profiles 605, 610 associated with the execution of model instructions 115A and obfuscation instructions 115B, respectively. Following the examples above, the measurable parameter profile 505 associated with the model instructions 115A indicates successively higher power or EM levels during the first, second, and third intervals and the measurable parameter profile 610 associated with the obfuscation instructions 115B indicates successively lower power levels or EM energy during the first, second, and third intervals. As shown in FIG. 6C, the measurable parameter profile 615 associated with the combined execution of these instructions is relatively constant, thus obfuscating the measurable parameter profile 505 associated with the obfuscated model 115.

In the examples above, the obfuscation instructions 115B are configured to obfuscate the model instructions 115A by canceling out the changes in the measurable parameter profile 615 associated with the model instructions 115A.

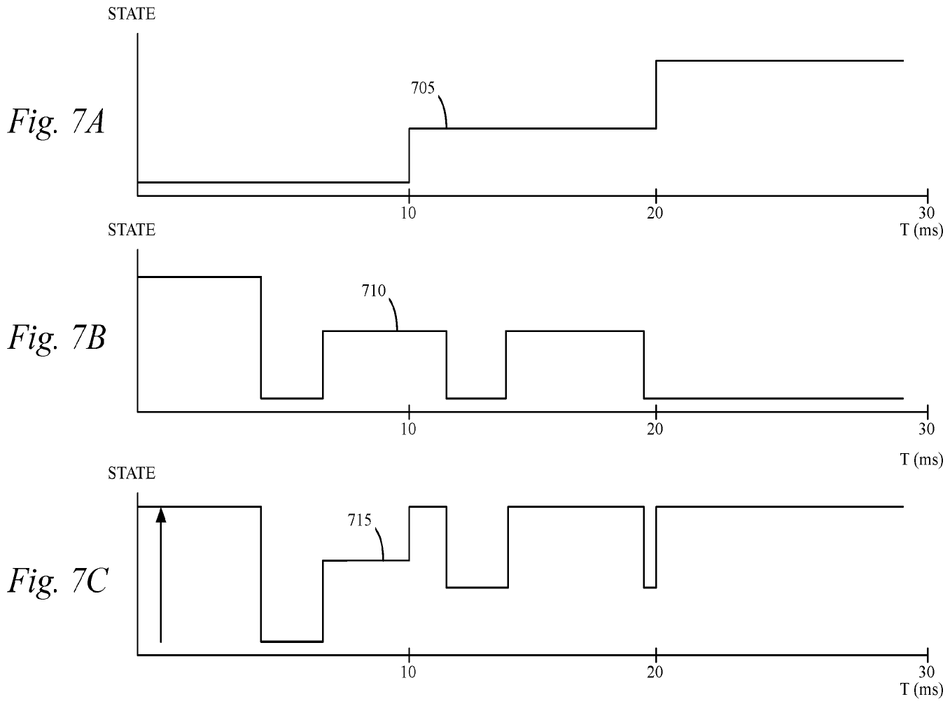

FIGS. 7A-7C illustrate examples of measurable parameter profiles 705, 710, 715 associated with the execution of obfuscation instructions 115B configured to make the changes in the measurable parameter profile 615 associated with the model instructions 115A appear random. The measurable parameter profile 705 in FIG. 7A corresponds to the measurable parameter profile in FIG. 5A. As shown in FIG. 7B, the measurable parameter profile 710 associated with the execution of the obfuscation instructions 115B is random when compared to the measurable parameter profile 705 associated with the model instructions 115A. As shown in FIG. 7C, the measurable parameter profile 715 associated with the combined profiles appears random, thus obfuscating the measurable parameter profile 705 associated with the model instructions 115A.

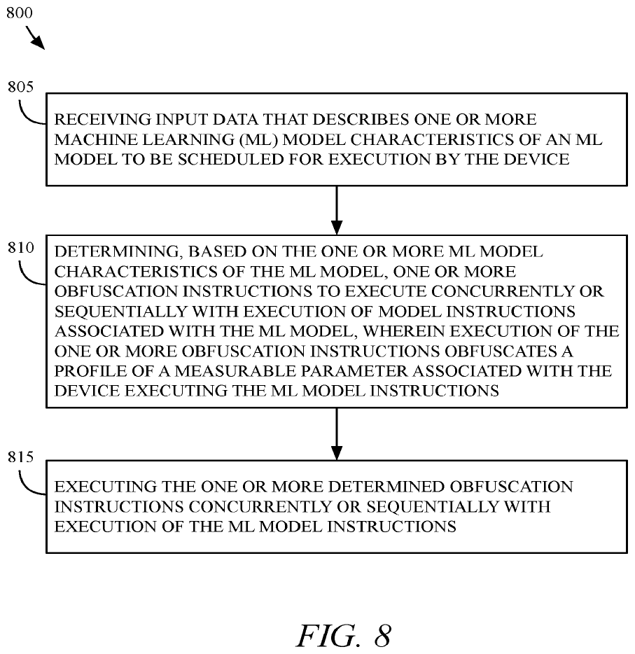

FIG. 8 illustrates an example of operations 800 performed by some examples of the device 105. The operations at block 805 involve receiving input data that describes one or more machine learning (ML) model characteristics of an ML model to be scheduled for execution by the device.

The operations at block 810 involve determining, based on the one or more ML model characteristics of the ML model, one or more obfuscation instructions to execute concurrently or sequentially with the execution of model instructions associated with the ML model. Execution of the one or more obfuscation instructions obfuscates a profile of a measurable parameter associated with the device executing the model instructions.

The operations at block 815 involve executing the one or more determined obfuscation instructions concurrently or sequentially with the execution of the model instructions.

In some examples, a number of the one or more obfuscation instructions executed is proportional to a number of the plurality of layers of the ML model.

In some examples, a number of the one or more obfuscation instructions executed is proportional to a number of nodes within each of the plurality of layers of the ML model.

In some examples, the processor comprises a plurality of processing units. In these examples, executing the one or more obfuscation instructions concurrently or sequentially with the execution of the model instructions involves executing the model instructions on a subset of the plurality of processing units, and executing the one or more obfuscation instructions on a different subset of the plurality of processing units.

In some examples, executing the one or more obfuscation instructions concurrently or sequentially with the execution of the model instructions involves executing one or more obfuscation instructions that render changes in the measurable parameter of the device due to execution of the model instructions substantially undetectable.

In some examples, executing the one or more obfuscation instructions concurrently or sequentially with the execution of the model instructions involves executing one or more obfuscation instructions that render changes in the measurable parameter of the device due to the execution of the model instructions substantially random.

In some examples, the measurable parameter corresponds to a power dissipation of the device. In these examples, executing the one or more obfuscation instructions involves executing one or more obfuscation instructions that modulate the power dissipation of the device to thereby obfuscate a power dissipation profile associated with the execution of the ML instructions.

In some examples, the measurable parameter corresponds to electromagnetic energy emanating from the device. In these examples, executing the one or more obfuscation instructions involves executing one or more obfuscation instructions that modulate the electromagnetic energy of the device to thereby obfuscate an electromagnetic energy profile associated with the model instructions.

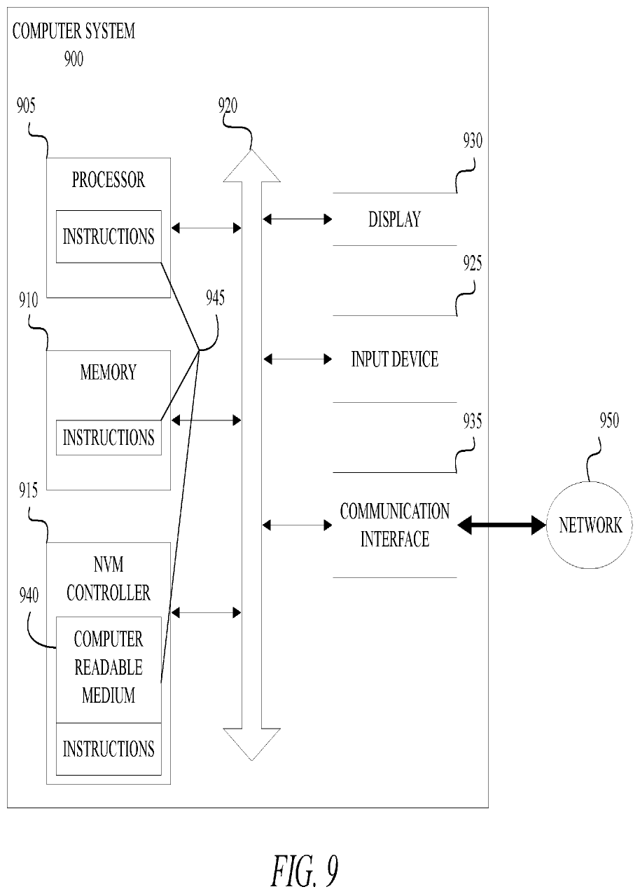

FIG. 9 illustrates an example of a computer system 900 that can form part of or implement any of the systems and/or devices described above. The computer system 900 can include a set of instructions 945 that the processor 905 can execute to cause the computer system 900 to perform any of the operations described above. An example of the computer system 900 can operate as a stand-alone device or can be connected, e.g., using a network, to other computer systems or peripheral devices.

In a networked example, the computer system 900 can operate in the capacity of a server or as a client computer in a server-client network environment, or as a peer computer system in a peer-to-peer (or distributed) environment. The computer system 900 can also be implemented as or incorporated into various devices, such as a personal computer or a mobile device, capable of executing instructions 945 (sequential or otherwise), causing a device to perform one or more actions. Further, each of the systems described can include a collection of subsystems that individually or jointly execute a set, or multiple sets, of instructions to perform one or more computer operations.

The computer system 900 can include one or more memory devices 910 communicatively coupled to a bus 920 for communicating information. In addition, code operable to cause the computer system to perform operations described above can be stored in the memory 910. The memory 910 can be random-access memory, read-only memory, programmable memory, or any other type of memory or storage device.

The computer system 900 can include a display 930, such as a liquid crystal display (LCD), organic light-emitting diode (OLED) display, or any other display suitable for conveying information. The display 930 can act as an interface for the user to see processing results produced by processor 905.

Additionally, the computer system 900 can include an input device 925, such as a keyboard or mouse or touchscreen, configured to allow a user to interact with components of system 900.

The computer system 900 can also include a non-volatile memory (NVM) controller 915. The NVM controller 915 can include a computer-readable medium 940 (e.g., flash drive) in which the instructions 945 can be stored. The instructions 945 can reside completely, or at least partially, within the memory 910 and/or within the processor 905 during execution by the computer system 900. The memory 910 and the processor 905 also can include computer-readable media, as discussed above.

The computer system 900 can include a communication interface 935 to support communications via a network 950. The network 950 can include wired networks, wireless networks, or combinations thereof. The communication interface 935 can enable communications via any number of wireless broadband communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A computer-implemented method performed on a device, the method comprising:
receiving input data that describes one or more machine learning (ML) model characteristics of an ML model;
determining, based on the one or more ML model characteristics of the ML model, one or more obfuscation instructions that are used to obfuscate a profile of a measurable parameter associated with the device when the device executes model instructions for the ML model; and
executing the one or more obfuscation instructions concurrently or sequentially with execution of the model instructions.

2. The computer-implemented method according to claim 1, wherein a number of the one or more obfuscation instructions executed is proportional to a number of layers of the ML model.

3. The computer-implemented method according to claim 2, wherein a number of the one or more obfuscation instructions executed is proportional to a number of nodes within each of the layers of the ML model.

4. The computer-implemented method according to claim 1, wherein the device comprises a plurality of processing units, wherein executing the one or more obfuscation instructions concurrently or sequentially with execution of the model instructions comprises:
executing the model instructions on a subset of the plurality of processing units; and
executing the one or more obfuscation instructions on a different subset of the plurality of processing units.

5. The computer-implemented method according to claim 1, wherein executing the one or more obfuscation instructions concurrently or sequentially with execution of the model instructions comprises:
executing one or more obfuscation instructions that render changes in the measurable parameter of the device due to execution of the model instructions substantially undetectable.

6. The computer-implemented method according to claim 1, wherein executing the one or more obfuscation instructions concurrently or sequentially with execution of the model instructions comprises:
executing one or more obfuscation instructions that render changes in the measurable parameter of the device due to execution of the model instructions substantially random.

7. The computer-implemented method according to claim 1, wherein the measurable parameter corresponds to a power dissipation of the device, wherein executing the one or more obfuscation instructions comprises:
executing one or more obfuscation instructions that modulate the power dissipation of the device to thereby obfuscate a power dissipation profile associated with the execution of the ML instructions.

8. The computer-implemented method according to claim 1, wherein the measurable parameter corresponds to electromagnetic energy emanating from the device, wherein executing the one or more obfuscation instructions comprises:
executing one or more obfuscation instructions that modulate the electromagnetic energy of the device to thereby obfuscate an electromagnetic energy profile associated with the model instructions.

9. A computing device comprising:
one or more processors; and
a memory in communication with the one or more processors, wherein the memory stores instruction code that, when executed by the one or more processors, causes the computing device to perform operations comprising:
receiving input data that describes one or more machine learning (ML) model characteristics of an ML model,
determining, based on the one or more ML model characteristics of the ML model, one or more obfuscation instructions that are used to obfuscate a profile of a measurable parameter associated with the computing device when the computing device executes model instructions for the ML model, and
executing the one or more obfuscation instructions concurrently or sequentially with execution of the model instructions.

10. The computing device according to claim 9, wherein a number of the one or more obfuscation instructions executed is proportional to a number of layers of the ML model.

11. The computing device according to claim 10, wherein a number of the one or more obfuscation instructions executed is proportional to a number of nodes within each of the layers of the ML model.

12. The computing device according to claim 9, wherein executing the one or more obfuscation instructions concurrently or sequentially with execution of the model instructions comprises:
executing the model instructions on a subset of the one or more processors; and
executing the one or more obfuscation instructions on a different subset of the one or more processors.

13. The computing device according to claim 9, wherein executing the one or more obfuscation instructions concurrently or sequentially with execution of the model instructions comprises:
executing one or more obfuscation instructions that render changes in the measurable parameter of the computing device due to execution of the model instructions substantially undetectable.

14. The computing device according to claim 9, wherein executing the one or more obfuscation instructions concurrently or sequentially with execution of the model instructions comprises:
executing one or more obfuscation instructions that render changes in the measurable parameter of the computing device due to execution of the model instructions substantially random.

15. The computing device according to claim 9, wherein the measurable parameter corresponds to a power dissipation of the computing device, wherein executing the one or more obfuscation instructions comprises:
executing one or more obfuscation instructions that modulate the power dissipation of the device to thereby obfuscate a power dissipation profile associated with the execution of the ML instructions.

16. The computing device according to claim 9, wherein the measurable parameter corresponds to electromagnetic energy emanating from the computing device, wherein executing the one or more obfuscation instructions comprises:
executing one or more obfuscation instructions that modulate the electromagnetic energy of the computing device to thereby obfuscate an electromagnetic energy profile associated with the model instructions.

17. A non-transitory computer-readable medium having stored thereon instruction code, wherein when executed by one or more processors of a computing device, the instruction code causes the computing device to perform operations comprising:
receiving input data that describes one or more machine learning (ML) model characteristics of an ML model;
determining, based on the one or more ML model characteristics of the ML model, one or more obfuscation instructions that are used to obfuscate a profile of a measurable parameter associated with the computing device when the computing device executes model instructions for the ML model; and
executing the one or more obfuscation instructions concurrently or sequentially with execution of the model instructions.

18. The non-transitory computer-readable medium according to claim 17, wherein a number of the one or more obfuscation instructions executed is proportional to a number of layers of the ML model.

19. The non-transitory computer-readable medium according to claim 18, wherein a number of the one or more obfuscation instructions executed is proportional to a number of nodes within each of the layers of the ML model.

20. The non-transitory computer-readable medium according to claim 17, wherein executing the one or more obfuscation instructions concurrently or sequentially with execution of the model instructions comprises:
executing the model instructions on a subset of the one or more processors; and
executing the one or more obfuscation instructions on a different subset of the one or more processors.
